(19) United States
(12) Patent Application Publication
(10) Pub. No.: US 2012/0084365 A1
(43) Pub. Date: Apr. 5, 2012

(54) DELIVERING RESOURCE FILES TO PRINTERS USING EMAIL

(75) Inventor: Timothy Louis McCann, JR., Longmont, CO (US)

(73) Assignee: KONICA MINOLTA SYSTEMS LABORATORY INC., Huntington Beach, CA (US)

(21) Appl. No.: 12/895,552

(22) Filed: Sep. 30, 2010

(51) Int. Cl. G06F 15/16

(52) U.S. Cl. 709/206

(57) ABSTRACT

A method for managing printers, including retrieving, by a printer, an email sent to an email address of the printer and including a resource file, identifying, by the printer, a field within the email including a type of the resource file, and installing, by the printer, the resource file on the printer based on the type.

### BACKGROUND OF INVENTION

Electronic mail, also referred to as email or e-mail, is a method of exchanging digital messages across the Internet or other computer networks. Originally, email was transmitted directly from one user's computer to another computer. This required both computers to be online at the same time. Today's email systems are based on a store-and-forward model. Email servers accept, forward, deliver and store messages. Users no longer need be online simultaneously and need only connect briefly, typically to an email server, for as long as it takes to send or receive messages.

An email client, also referred to as email reader, or mail user agent, is a computer program used to manage a user's email. In addition, Web-based email applications are referred to as webmail and allow user to manage the emails using a web browser.

An organization (e.g., a corporation, an enterprise, or other types of large companies) may purchase multiple duplicate products to be installed and used, for example, in diverse geographical locations. Such multiple duplicate products may include printers, fax machines, photocopiers, computers, network devices, etc. In an enterprise situation, it can be a complicated task to maintain and update these devices in large quantities. For example, enterprise users often have a need to maintain and update multiple resource files (e.g., fonts, forms, macros, color profiles, etc.) on a large number of printers. In almost every case, these users want a way to load the same data onto multiple print systems without having to manually load it one at a time to every print system on the enterprise network.

### SUMMARY OF INVENTION

In general, in one aspect, the invention relates to a method for managing printers. The method includes retrieving, by a printer, an email sent to an email address of the printer and comprising a resource file, identifying, by the printer, a field within the email comprising a type of the resource file, and installing, by the printer, the resource file on the printer based on the type.

In general, in one aspect, the invention relates to a printer, including a hardware processor, a memory operatively connected to the hardware processor, and instructions stored in the memory and including functionality to retrieve an email sent to an email address of the printer and comprising a resource file, identify a field within the email comprising a type of the resource file, and install the resource file on the printer based on the type.

In general, in one aspect, the invention relates to a computer readable storage medium storing instructions for managing printers. The instructions includes functionality to retrieve an email sent to an email address of a printer and comprising a resource file, identify a field within the email comprising a type of the resource file, and install the resource file on the printer based and the type.

In general, in one aspect, the invention relates to a system for managing printers. The system includes a client computer configured to generate an email addressed to a group email address and comprising a resource file, a mail server operatively connected to the client computer and configured to send the email to a number of email addresses corresponding to the group email address, and a number of printers having email addresses and configured to identify a field within the email including a type of the resource file and install the resource file on the number of printers based on the type.

Other aspects of the invention will be apparent from the following description and the appended claims.

### BRIEF DESCRIPTION OF DRAWINGS

FIG. 1 shows a block diagram of a system in accordance with one or more embodiments of the invention.

FIG. 2 shows a flowchart of a method in accordance with one or more embodiments of the invention.

FIGS. 3 and 4 show examples in accordance with one or more embodiments of the invention.

FIG. 5 shows a diagram of a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

An email message consists of three components, the message header, message attachments, and the message body, which is the email's content. The message header contains control information, including at least an originator's (i.e., sender's) email address and one or more recipient email addresses. Usually additional information is also included, such as a subject field. An email attachment is a computer file sent along with an email message. One or more files can be attached to any email message, and be sent along with it to the recipient. In particular, Multipurpose Internet Mail Extensions (MIME) defines standardized protocols for multi-media content attachments. Throughout this disclosure, the term “email attachment” refers to a computer file attached to the email based on MIME or any suitable protocol that may be developed in the future.

A printer is a peripheral which produces a hard copy (i.e., permanent readable text and/or graphics, usually on physical print media such as paper, transparencies, microfilm, etc.) from documents stored in electronic form. Some printers are primarily used as local peripherals, each being a stand alone device attached by a printer cable or a USB cable to a computer which serves as a document source. Other printers, referred to as network printers, have built-in network interfaces, typically wireless and/or Ethernet based, and can serve as a hard copy device for any user on the network. Many printers are designed to support both local and network connected users at the same time.

Printers that include non-printing features are sometimes referred to as multifunction printers (MFP), multi-function devices (MFD), or all-in-one (AIO) printers. Most MFPs include printing, scanning, and copying among their features. A print system may have many different configurations, e.g., a printer coupled to a single computer, one or more printers coupled to a print server (e.g., a dedicated computer), etc. Throughout this disclosure, the term “printer” may be used to refer to a network printer, a local printer, a MFP, or a print system, depending on the context.

In general, embodiments of the invention provide for a system and method to deliver resource files to one or more printers using email (referred to as resource file email delivery feature) by including an email agent in a printer or a print system. By adding the email agent to the printer, the printer can retrieve files attached to emails for processing whenever the printer is connected to the mail server. If a user attaches a file (i.e., the resource file) that contains a form to be stored or a font to be downloaded, a single email from the user can be sent to an email alias (i.e., a forwarding email address to a group of email addresses) that would add the email to the inbox of multiple printers. All printers having email addresses associated with that email alias could then retrieve the email and the attached file from the inbox. Accordingly, each printer may then identify the type of the attachment and perform some action on the attached file. Acting upon the attached file causes, for example, the file to be saved and/or managed according to the file type, etc.

In one or more embodiments of the invention, the email message contents include fields that can be used in tracking, configuring, and limiting access to the resource file email delivery feature. In one or more embodiments, the sender field (i.e., the field identifying who the email is from) may be used to restrict access or maintain job accounting. For example, only emails coming from approved email sender accounts activate the resource file email delivery feature. In another example, the sender name of the email may be recorded in a maintenance log kept by the printer. In one or more embodiments, the subject field (i.e., the field containing the email subject) may be used to identify the attached resource file, such as PCL FONT 93 or PCL MACRO 17, where PCL FONT and PCL MACRO refer to specific types of resource files, and 93 and 17 are unique identification (ID) values for the resource files.

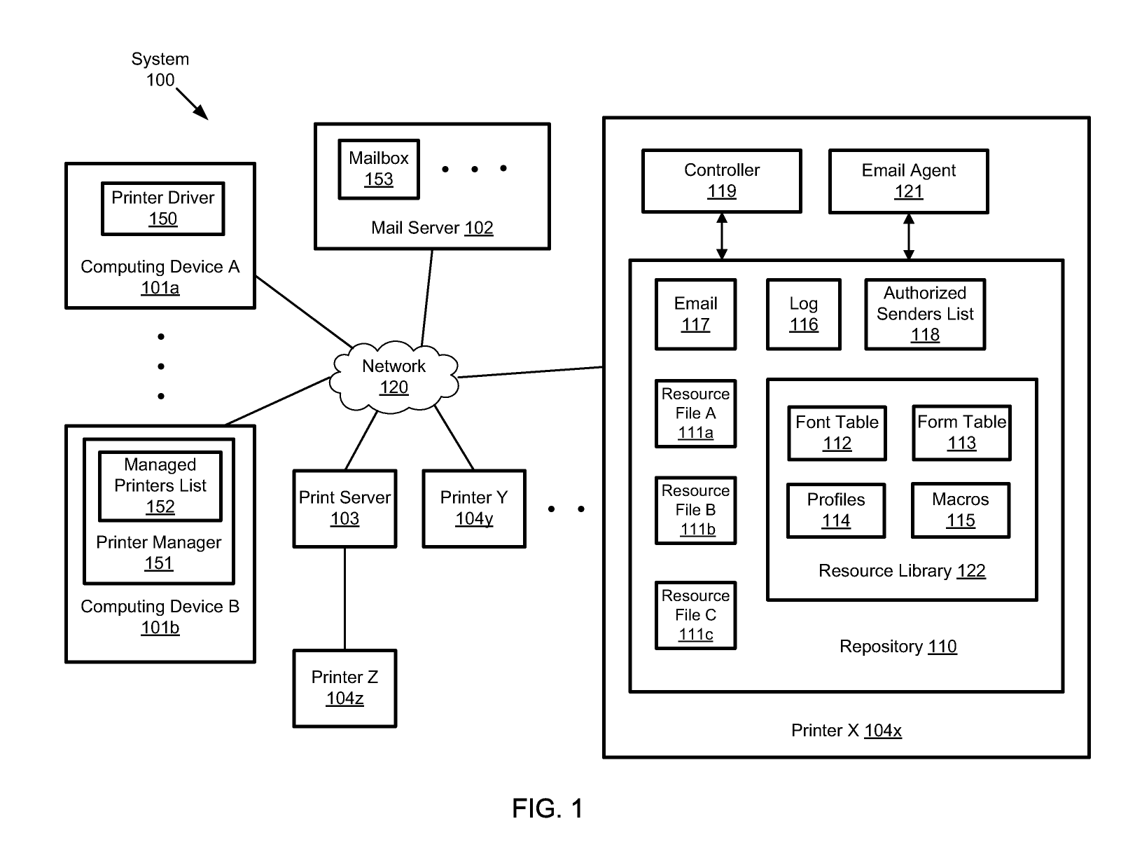

FIG. 1 depicts a schematic block diagram of a system (100) in accordance with one or more embodiments of the invention. In one or more embodiments of the invention, one or more of the modules and elements shown in FIG. 1 may be omitted, repeated, and/or substituted. Accordingly, embodiments of the invention should not be considered limited to the specific arrangements of modules shown in FIG. 1. The system (100) of FIG. 1 depicts components for delivering resource files to printers using email.

As shown in FIG. 1, the system (100) includes multiple computing devices (e.g., computing device A (101a) and computing device B (101b)), mail server (102), print server (103), and multiple printers (e.g., printer X (104x), printer Y (104y), and printer Z (104z)), all of which are coupled via a computer network (120). In particular, the computer network (120) may be the Internet, a wide area network, a local area network, WIFI, or any other suitable network with wired and/or wireless segments. Further, the printer X (104x) includes controller (119), email agent (121), and repository (110). The repository (110) may be a database, persistent storage, computer memory, or any other suitable type of storage device or management system. The repository stores emails (e.g., email (117) stored in the computer memory), log (116), one or more resource files (e.g., resource file A (111a), resource file B (111b), and resource file C (111c)), authorized senders list (118), and resource library (122) having font table (112), form table (113), profiles (114) and macros (115). Further, each of the computing device A (101a) and the computing device B (101b) may be associated with a user (not shown) and may be one of a desktop computer, a notebook computer, a smart phone, a personal digital assistant (PDA), a cable box, a kiosk, a gaming console, or other hardware devices having computing capabilities.

In one or more embodiments of the invention, the computing device A (101a) is configured to send a print job to one or more of the printers (e.g., printer X (104x) and printer Y (104y)) in response to a user print command. Specifically, the computing device A (101a) may be installed with a printer driver (150) configured to format an electronic document (not shown) into the print job upon receiving the user print command. Further, the print job sent to the printer X (104x) may reference a font (i.e., a typeface), a form (e.g., an accounting form, a tax form, an inventory form, a memo form, a report template, etc.) a color profile (e.g., an International Color Consortium (ICC) profile), and/or a macro stored in the printer X (104x) and needed to create the hardcopy document from the print job. In one or more embodiments, the referenced fonts, forms, profiles, and macros may be stored in font table (112), form table (113), profiles (114) and macros (115), respectively, of the resource library (122). For example, the print job may reference “PCL FONT 93” or “93” in order to print the document using the referenced font. The printer X (104x) will access the detailed typeface specification of the referenced font stored in the font table (112) under the index of “PCL FONT 93,” “93,” or some similar identifier.

In addition to fonts, forms, profiles, and macros, the printer X (104x) may include other attributes that customize the style, format, color, or other characteristics (e.g., appearance, quality, printing efficiency, power saving configuration, etc.) of the printed hard copy or the printer itself. The font, form, profile, macro, and these additional attributes are referred to as resources or printer resources. In one or more embodiments, all types of resources are stored in the resource library (122) in a pre-determined format that can be easily accessed to control the printing process. In one or more embodiments, a resource file (e.g., resource file A (111a), resource file B (111b), or resource file C (111c)) contains the specification of one or more resources and the resource library (122) may be updated based on the content of such resource file.

In one or more embodiments of the invention, the printer X (104x) includes controller (119) configured to receive the print job sent from the computing device A (101a) over the network (120) and generate necessary data to drive the printing mechanism (not shown) based on the font, form, profile, macro or other resources referenced in the print file. The printing mechanism includes the necessary electronic and/or mechanical components for producing the hardcopy. In one or more embodiments, the controller (119) is configured to access the resource library (122) for retrieving the detailed specification of the font, form, profile, macro, or other resources referenced in the print job. For example, the controller (119) may generate a bit mapped image file for driving a laser printer drum based on the text information in the print file as well as the retrieved typeface specification of the “PCL FONT 93” referenced in the print file.

In one or more embodiments of the invention, the computing device B (101b) includes a printer manager (151) configured to send an email to the printer X (104x) in response to a user update command. For example, the user associated with the computing device B (101b) may be a system administrator authorized to update the resource library (122) of the printer X (104x). Such an email is referred to as a resource update email (not shown). In one or more embodiments, the printer manager (151) maintains a managed printers list (152) identifying all printers (e.g., printer X (104x)) capable of receiving resource update emails for updating resource libraries. New printers may be added to the managed printers list (152) via user input, by a discovery process invoked by the computing device B (101b) to seek out new printers, by a registration protocol between the computing device B (101b) and the printer X (104x), or combinations thereof.

In one or more embodiments of the invention, the mail server (102) includes a Mail Transfer Agent (MTA) server using a suitable mail delivery agent (MDA). In one or more embodiments, the printer X (104x) is associated with an email address corresponding to mailbox (153) on the mail server (102). In particular, the aforementioned resource update email is sent from the computing device B (101b) to the printer X (104x) using the associated email address. Accordingly, the resource update email is delivered by the mail server (102) to the mailbox (153). In one or more embodiments, each printer (e.g., printer X (104x), printer Y (104y), and printer Z (104z)) included in managed printers list (152) is associated with a separate email address corresponding to separate mailbox (e.g., mailbox (153), etc.) on the mail server (102). In one or more embodiments of the invention, the printer manager (151) is configured to send an email to all printers included in the managed printers list (152) using an email. In one or more embodiments, the one or more email addresses and alias email addresses are included in the managed printers list (152) along with the associated printers.

In one or more embodiments of the invention, the printer X (104x) includes email agent (121) configured to retrieve (e.g., based on Post Office Protocol (POP) or the Internet Message Access Protocol (IMAP)) the email from the mailbox (153) or some future email protocol mechanism and save the email and file attachment as the email (117) and the resource file A (111a), respectively. For example, the email agent (121) may be configured to check the mail box (153) for newly arrived resource update email based on a pre-determined schedule (e.g., hourly, daily, weekly, monthly, upon completing each print job, prior to starting a print job, upon powering up, upon exiting power saving mode, etc.). In one or more embodiments, the resource update email may be deleted from the mailbox (153) subsequent to being retrieved by the printer X (104x). In one or more embodiments, the email agent (121) is further configured to maintain the log (116) that stores information regarding email activities such as sender information, attachment type, time stamp, authorization verification status, etc. of the received emails (e.g., email (117)).

In one or more embodiments, the sender field of the email (117) contains an identification of the sender while the subject field of the email (117) contains a type and unique identifier (ID) of an resource file attached to the email. Alternatively, the body of the email may include the type and unique ID of the attached resource file. The detailed typeface specification of the new font “PCL FONT 93” may be added to the printer X (104x) by sending the printer X (104x) an email with an attached resource file corresponding to the new font “PCL FONT 93.” The subject field or body of this email would identify the type of the resource file and a unique ID of the resource file. The attached resource file may replace an existing resource file stored on the printer X (104x) having the same unique ID for purposes of updating or replacing the contents of the file.

In one or more embodiments of the invention, the email agent (121) is further configured to extract sender information from the sender field of the email (117) for authorization verification. Specifically, the sender information is compared to the authorized senders list (118) stored in the repository (110). If a match is found, the resource specified in the attached resource file is installed onto the printer X (104x) (i.e., added to the repository (122)). For example, once the sender is verified as an authorized sender, the controller (119) may add the new font “PCL FONT 93” to the font table (112). Specifically, the controller (119) stores the typeface specification in the resource file A (111a) in the font table (112) indexed by the reference “PCL FONT 93” or “93”. There may be a different sender list for each type of resource (i.e., sender A may be permitted to install fonts but not forms, while sender B may be permitted to install color profiles but not fonts, etc.).

In one or more embodiments, various resource files may be organized in the resource library (122) based on the resource file types and IDs. For example, various fonts may be organized in the font table (112) in a hierarchical structure. Although the example given here uses “PCL FONT 93” to specify the type and unique ID of the resource, other choices of keywords and/or formats may also be used.

In one or more embodiments, the email (117) may include additional attached files saved, for example as resource file B (111b) and resource file C (111c). Alternatively, the resource file B (111b) and the resource file C (111c) may be obtained from separate emails (not shown) sent from multiple administrator computing devices (not shown). In one or more embodiments, the resource file B (111b) and the resource file C (111c) may include one or more of font, form, profile, macro, and other resources to be added to the resource library (122). In one or more embodiments of the invention, when a single email has multiple attached files, the body of the single email includes the name of each attached file and the corresponding unique ID (e.g., “PCL Font 37 FontName1.fnt,” PCL Macro 190 Macro001.mac,” “PS Form RealEstateForm143.ps,” etc.).

In one or more embodiments of the invention, the print server (103) is a computer or device that is connected to one or more printers either directly (e.g., printer Z (104z)) or over the network (120) (e.g., printer Y (104y)). Specifically, the print server (103) is configured to accept print jobs from the computing device A (101a) for processing and/or directing to the appropriate printer. In one or more embodiments, the print server (103) is a host computer. Alternatively, the print server (103) is a dedicated machine. The print server (103) may implement a printing protocol (e.g., Internet Printing Protocol (IPP), Line Printer Daemon (LDR, LPR) protocol, TCP Port 9100 or RAW printer protocol, Data Link Control (DLC) protocol, etc.) for the printer Y (104y) and/or printer Z (104z). Specifically, the print server (103) provides printing protocol conversion from data sent by the computing device A (101a) to converted data that is accepted by the printer (e.g., printer Y (104y) and/or printer Z (104z)). In one or more embodiments, the print server (103) may be integrated with other devices (not shown) such as a wireless router, a network firewall, etc. In one or more embodiments, the printer Y (104y) and/or printer Z (104z) may have essentially the same configuration as the printer X (104x). In one or more embodiments, at least a portion of such controller, email agent, and information stored in repository may be included on the print server (103) to be shared by the printer Y (104y) and/or printer Z (104z).

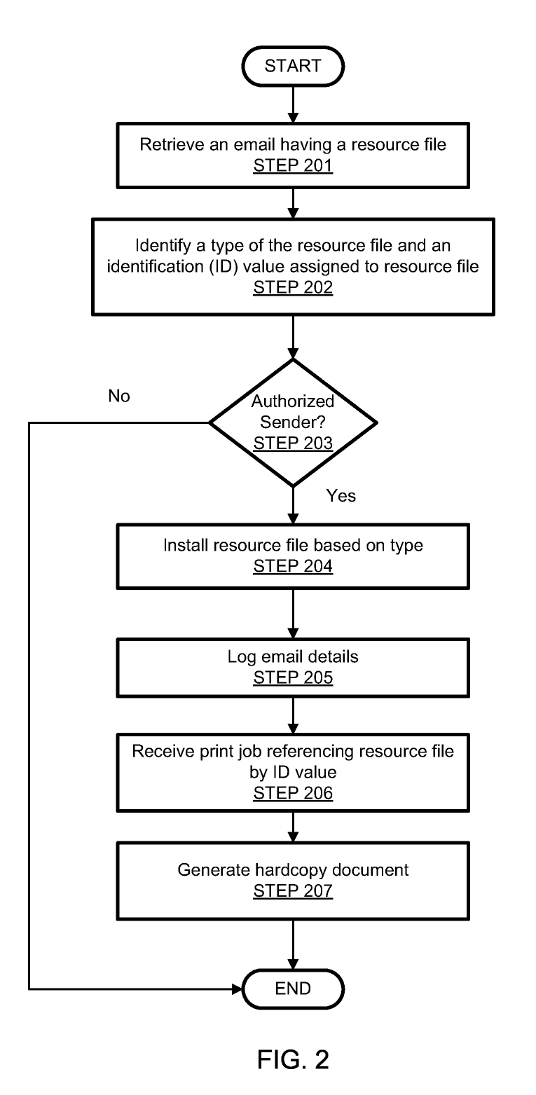

FIG. 2 depicts a flowchart of a method in accordance with one or more embodiments of the invention. In one or more embodiments of the invention, the method of FIG. 2 may be practice using the system (100) described in reference to FIG. 1 above. In one or more embodiments of the invention, one or more of the steps shown in FIG. 2 may be omitted, repeated, and/or performed in a different order. Accordingly, embodiments of the invention should not be considered limited to the specific arrangements of steps shown in FIG. 2.

Initially in STEP 201, an email having an attached resource file is sent to one or more printers using the email address of the printers or an email alias associated with all of the printers. The resource file defines/specifies a resource (e.g., a font, a form, a color profile, a macros, etc.) that may be referenced by a future print job and required to generate a hardcopy based on the print job. In one or more embodiments, the email is retrieved by the printer from a mailbox on a mail server associated with the email address. The mailbox (153) may be checked for new emails on a pre-determined schedule (e.g., hourly, daily, weekly, monthly, upon completing each print job, prior to starting a print job, upon powering up, upon exiting power saving mode, etc.).

In STEP 202, the type of the resource and or unique ID assigned to the resource is identified by the printer from a field (e.g., the subject field) within the email. The unique ID may be set by the sender of the email. For example, the string “PCL FONT 93” may be stored in the subject field of the email. The characters “PCL FONT” in the string identify the type of the resource while the characters “93” identify the unique ID assigned to the resource. In one or more embodiments, the type of the resource and the ID value are stored within the resource file.

In STEP 203, it is determined by the printer whether the email is from an authorized sender. In one or more embodiments, the sender of the email (e.g., identified from the sender field of the email) is compared with a list of authorized senders associated with the resource file type. When it is determined that that the email is from an authorized sender based on a match, the method proceeds to STEP 204. When it is determined that the email is not from an authorized sender (i.e., no match in the list of authorized senders), the email is discarded and the process ends. In one or more embodiments of the invention, the email details (e.g., sender, resource type, timestamp, unique ID) are logged prior to ending the process.

In STEP 204, the resource file is installed on the printer based on the type. In one or more embodiments, installing the resource file includes overwriting a previously downloaded resource file associated with the type and stored on the printer. For example, the type of the resource file may be a font, and installing the resource file on the printer includes updating a font table of the printer to include the new font. In another example, the type of the resource file may be a form, and installing the resource file on the printer includes updating a form table of the printer to include the new form. In yet another example, the type of the resource file may be a color profile, and installing the resource file on the printer includes updating a color profile library of the printer to include the new color profile.

In STEP 205, the email details are recorded by the printer in a log. In one or more embodiments, each log entry identifies the email, the type of the resource, the filename of the resource file, the sender, a timestamp, and other email information. From time to time, the printer may receive a query for the log. Accordingly, the printer may send the entire log or specific entries in the log in response to the query.

In STEP 206, the printer may receive a print job referencing the resource by the unique ID value. For example, the print job may reference “PCL FONT 93” or “93” when specifying a font to use. The printer must access the resource specified in the print job in order to generate the hardcopy document (STEP 207) based on the print job.

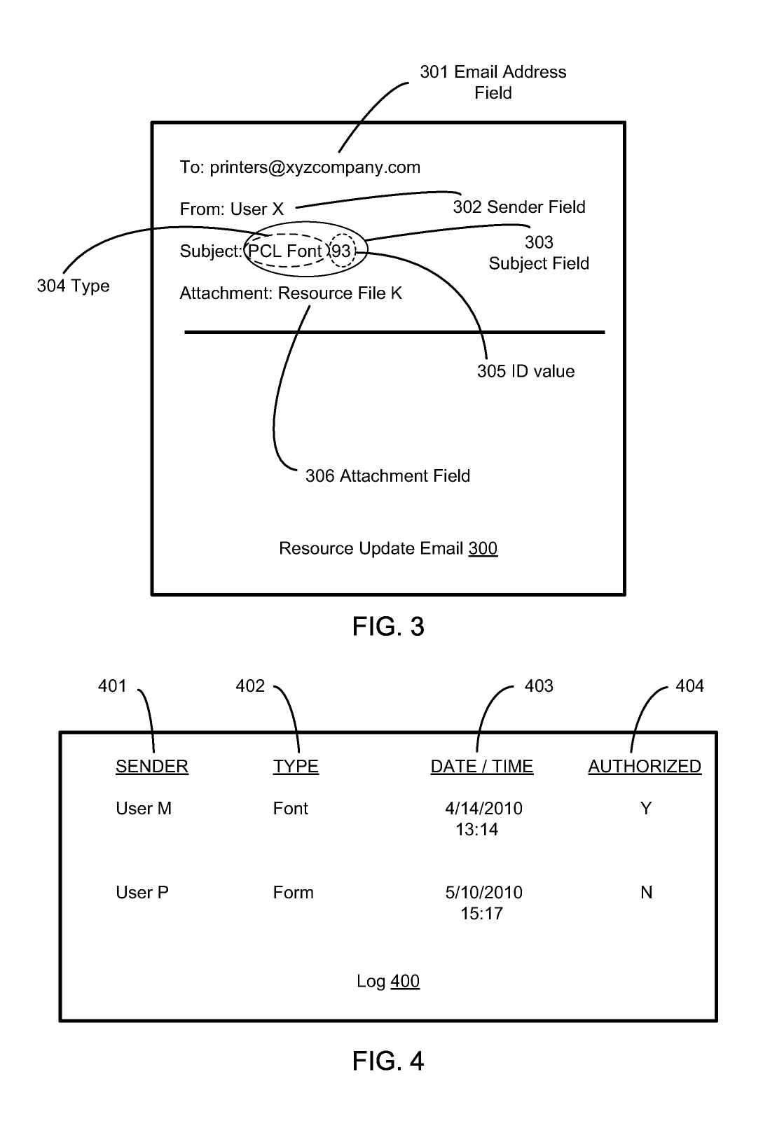

FIGS. 3 and 4 depict an example in accordance with one or more embodiments of the invention. Specifically, FIG. 3 shows an example resource update email (300). As shown in FIG. 3, the resource update email (300) includes email address field (301) containing the email address “printers@xyzcompany.com”, sender field (302) containing a sender “User X”, subject field (303) containing a type (304) of the resource (i.e., “PCL FONT”) and a unique ID value (305) of the resource (i.e., “93”), and attachment field (306) containing a file name of the attached resource file (i.e., “Resource File K”). Specifically, the resource update email (300) is sent from an administrator user “User X” to the email address “printers@xyzcompany.com” that is associated with all printers of a particular model in the xyz company. In this example, the resource update email (300) includes an attached printer font file identified by ID “93”. Once the email is retrieved by the printers and processed by the printers, the new font will be installed on the multiple printers and made available for printing incoming print jobs.

FIG. 4 shows an example log (400) in accordance with one or more embodiments of the invention. The log (400) may be essentially the same as the log (116) discussed above in reference to FIG. 1. As shown in FIG. 4, the log (400) includes sender column (401) containing “User M” and “User P”, resource type column (402) containing “Font” and “Form”, date/time column (403) containing “Apr. 14, 2010 13:14” and “May 10, 2010 15:17”, and authorization status column (404) containing “Y” and “N”. Specifically, the first entry in the log (400) identifies a resource update email sent from “User M” with an attached printer font resource file and time stamped at Apr. 14, 2010 13:14. The first log entry indicates that this resource update email is authorized (i.e., “User M” is an authorized user to update printer fonts). Accordingly, this new font was installed on the printer. The second entry in the log (400) identifies another resource update email sent from “User P” with an attached printer form resource file and time stamped at May 10, 2010 15:17. The second log entry indicates that this resource update email is not authorized (i.e., “User P” is not an authorized user to update printer form). Accordingly, this new form was not installed on the printer.

One or more embodiments of the invention have the following advantages: the ability to upload the same set of resource files to multiple printers in multiple locations around the world using a single email; the ability to log resource files added to the printer using email; the ability to restrict users from changing/adding resource files to printers through email; and the ability to restrict users from changing/adding resource files to printers according to the type of resource file.

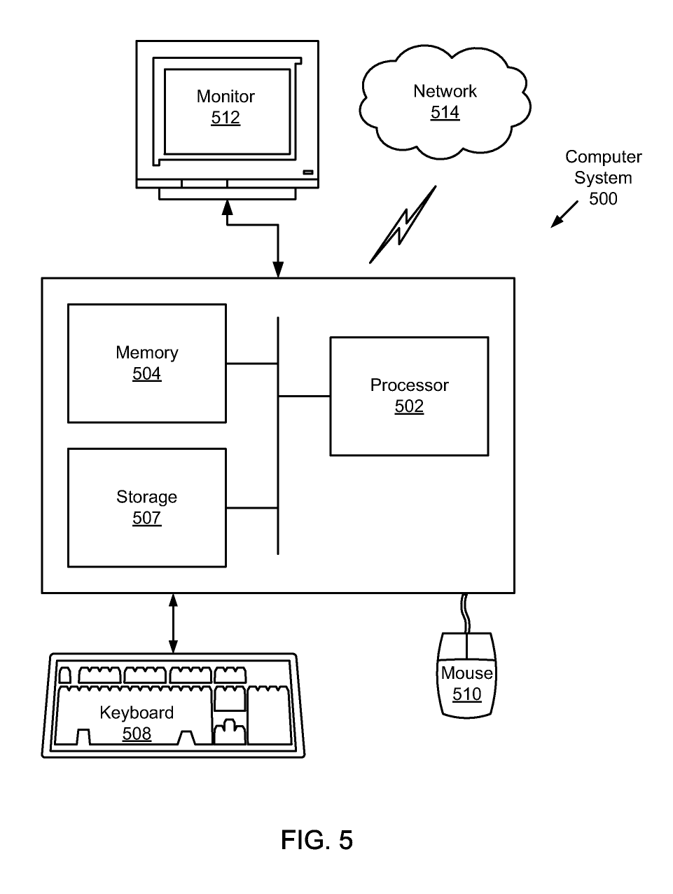

Embodiments of the invention may be implemented on virtually any type of computer regardless of the platform being used. For example, as shown in FIG. 5, a computer system (500) includes one or more processor(s) (502) (such as a central processing unit (CPU), integrated circuit, etc.), associated memory (504) (e.g., random access memory (RAM), cache memory, flash memory, etc.), a storage device (507) (e.g., a hard disk, an optical drive such as a compact disk drive or digital video disk (DVD) drive, a flash memory stick, etc.), and numerous other elements and functionalities typical of today's computers (not shown). The computer system (500) may also include input means, such as a keyboard (508), a mouse (510), or a microphone (not shown). Further, the computer system (500) may include output means, such as a monitor (512) (e.g., a liquid crystal display (LCD), a plasma display, or cathode ray tube (CRT) monitor), and/or audio speakers. The computer system (500) may be connected to a network (514) (e.g., a local area network (LAN), a wide area network (WAN), the Internet, or any other type of network) via a network interface connection (not shown). Those skilled in the art will appreciate that many different types of computer systems exist, and the aforementioned input and output means may take other forms. Generally speaking, the computer system (500) includes at least the minimal processing, input, and/or output means necessary to practice embodiments of the invention.

Further, in one or more embodiments of the invention, one or more elements of the aforementioned computer system (500) may be located at a remote location and connected to the other elements over a network. Further, embodiments of the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, a tape, memory, punch cards, or any other tangible computer readable storage device.

While the invention has been described with respect to a limited number of embodiments, those skilled in the art, having benefit of this disclosure, will appreciate that other embodiments can be devised which do not depart from the scope of the invention as disclosed herein. For example, although the description above uses email to deliver the printer resource files, it is contemplated that other means of electronic messaging, such as multimedia messaging service (MMS) sent from a mobile phone, instant messaging (IM) sent from a computer, etc., may also be used to deliver printer resource files as MMS attachment, IM attachment, or other types of message attachments. In such embodiments, the email agent in the printer may include a MMS client, IM client, etc. Further, although the description above uses the email to deliver printer resource files, it is contemplated that email or the aforementioned means of electronic messaging may also be used to deliver resource files for other types of other electronic devices. Accordingly, the scope of the invention should be limited only by the attached claims.

1. A method for managing printers, comprising:
retrieving, by a printer, an email sent to an email address of the printer and comprising a resource file;
identifying, by the printer, a field within the email comprising a type of the resource file; and
installing, by the printer, the resource file on the printer based on the type.

2. The method of claim 1, wherein installing the resource file comprises overwriting a previously downloaded resource file associated with the type and stored on the printer.

3. The method of claim 1, further comprising:
identifying a sender of the email; and
comparing, by the printer and prior to installing the resource file, the sender of the email with a list of authorized senders associated with the type.

4. The method of claim 1, further comprising:
identifying, by the printer and within the email, an identification (ID) value assigned to the resource file; and
storing, by the printer, the ID value with the resource file.

5. The method of claim 4, further comprising:
receiving, by the printer, a print job referencing the resource file by the ID value; and
generating, by the printer, a hardcopy document based on the print job by accessing the resource file.

6. The method of claim 1, wherein the email is sent to an address group comprising a plurality of email addresses for a plurality of printers.

7. The method of claim 1, wherein the type of the resource file is a font, and wherein installing the resource file on the printer comprises updating a font table of the printer.

8. The method of claim 1, wherein the type of the resource file is a form.

9. The method of claim 1, wherein the resource file is a color profile.

10. The method of claim 1, wherein the resource file is a macro file.

11. The method of claim 1, further comprising:
creating, by the printer and in a log, a log entry identifying the email, the type, the resource file, and the sender;
receiving, by the printer, a query for the log; and
sending, by the printer, the log in response to the query.

12. A printer comprising:
a hardware processor;
a memory operatively connected to the hardware processor; and
a plurality of instructions stored in the memory and comprising functionality to:
retrieve an email sent to an email address of the printer and comprising a resource file;
identify a field within the email comprising a type of the resource file; and
install the resource file on the printer based on the type.

13. The printer of claim 12, wherein the instructions further comprise functionality to:
identify a sender of the email; and
compare, prior to installing the resource file, the sender of the email with a list of authorized senders associated with the type.

14. The printer of claim 12, wherein the instructions further comprise functionality to:
identify, within the email, an identification (ID) value assigned to the resource file; and
storing, by the printer, the ID value with the resource file.

15. The printer of claim 12, wherein the type of the resource file is at least one selected from a group consisting of a font, a form, and a color profile.

16. A non-transitory computer readable storage medium storing instructions for managing printers, the instructions comprising functionality to:
retrieve an email sent to an email address of a printer and comprising a resource file;
identify a field within the email comprising a type of the resource file;
install the resource file on the printer based and the type.

17. The non-transitory computer readable storage medium of claim 16, the instructions further comprising functionality to:
identify a sender of the email; and
compare, prior to installing the resource file, the sender of the email with a list of authorized senders associated with the type.

18. The non-transitory computer readable storage medium of claim 16, the instructions further comprising functionality to:
identify, the email, an identification (ID) value assigned to the resource file; and
storing the ID value with the resource file on the printer.

19. A system for managing printers, comprising:
a client computer configured to generate an email addressed to a group email address and comprising a resource file;
a mail server operatively connected to the client computer and configured to send the email to a plurality of email addresses corresponding to the group email address; and
a plurality of printers comprising the plurality of email addresses and configured to identify a field within the email comprising a type of the resource file and install the resource file on the plurality of printers based on the type.

20. The system of claim 19, wherein the plurality of printers are further configured to:
identify, within the email, an identification (ID) value assigned to the resource file; and
storing the ID value with the resource file.

21. The system of claim 19, wherein the type of the resource file is a font, and wherein installing the resource file comprises updating a plurality of font tables in the plurality of printers.
